(19) United States
(12) Patent Application Publication
(10) Pub. No.: US 2025/0008878 A1
(43) Pub. Date: Jan. 9, 2025

(54) A DEVICE FOR CARRYING OUT AGRICULTURAL PROCESSING

(71) Applicant: Ploeger Oxbo Europe B.V., Roosendaal (NL)

(72) Inventors: Hendrik Willem BREURE, Roosendaal (NL); Marinus Adriaan GROOTJANS, Roosendaal (NL)

(21) Appl. No.: 18/710,566

(22) PCT Filed: Nov. 9, 2022
(86) PCT No.: PCT/NL2022/050636

§ 371 Date: May 15, 2024

(30) Foreign Application Priority Data
Nov. 15, 2021 (NL) 2029754

(51) Int. Cl. A01D 80/00; A01D 78/04

(52) U.S. Cl. CPC A01D 80/00; A01D 78/04

(57) ABSTRACT

A device for carrying out agricultural processing is movable in a direction of travel over land. The device is provided with at least one elongate pick-up mechanism for picking up a product from the land, at least one conveyor belt which is positioned with respect to the elongate pick-up mechanism in such a way that the product picked up from the land by the elongate pick-up mechanism can be moved in the direction of the conveyor belt. The product can be conveyed by the conveyor belt in at least one transport direction extending lateral to the direction of travel and can be deposited on the land. An elongate rotor unit is arranged above the elongate pick-up mechanism.

The invention relates to a device for carrying out agricultural processing which is movable in a direction of travel over land, wherein the device is provided with:
at least one elongate pick-up mechanism for picking up a product from the land,
at least one conveyor belt which is positioned with respect to the elongate pick-up mechanism in such a way that the product picked up from the land by means of the elongate pick-up mechanism can be moved in the direction of the conveyor belt, wherein by means of the conveyor belt the product can be conveyed in at least one transport direction extending lateral to the direction of travel and can be deposited on the land, and
   an elongate rotor unit which is arranged above the elongate pick-up mechanism, wherein in use a product passage is provided between the elongate rotor unit and the elongate pick-up mechanism in the direction of the conveyor belt, wherein the elongate rotor unit comprises:
   an elongate rotor comprising an elongate shaft which is rotatable around a rotation axis and radially outwardly from the elongate shaft extending rotor elements defining a maximum radius of the elongate rotor with respect to the rotation axis, and
   a non-rotatable part.

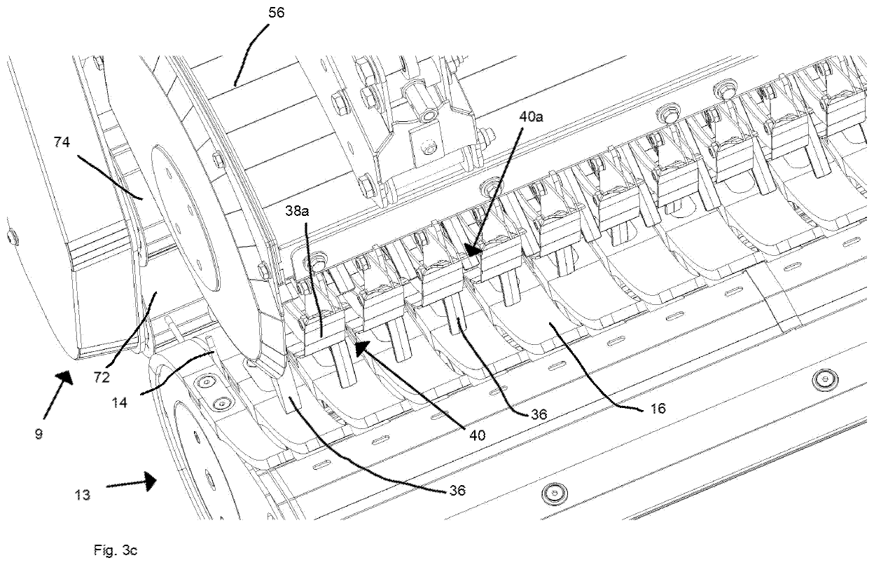

Such a device is known from WO 2020/242303, see for example FIG. 3 of this document showing an elongate rotor unit indicated with reference sign 31. The known rotor unit is arranged above the lifting (or pickup) mechanism (13a), wherein a product passage, denoted by arrow d3, can be provided between the elongate rotor unit and the lifting mechanism, in the direction of the conveyor belt. The known device provides excellent results for carrying out agricultural processing on the land at relatively high speeds of travel.

One object of the present invention is further improvement of the agricultural processing that is to be carried out by means of the device. In a further aspect, an object is to improve the product flow between the elongate pick-up mechanism and the elongate rotor unit and/or to reduce the risk of clogging of product in the elongate rotor unit.

At least one of these objects is achieved with the device for carrying out agricultural processing such as is defined in claim 1.

The device is movable in a direction of travel over land, wherein the device is provided with:
at least one elongate pick-up mechanism for picking up a product from the land,
at least one conveyor belt which is positioned with respect to the elongate pick-up mechanism in such a way that the product picked up from the land by means of the elongate pick-up mechanism can be moved in the direction of the conveyor belt, wherein by means of the conveyor belt the product can be conveyed in at least one transport direction extending lateral to the direction of travel and can be deposited on the land, and
an elongate rotor unit which is arranged above the elongate pick-up mechanism, wherein in use a product passage is provided between the elongate rotor unit and the elongate pick-up mechanism in the direction of the conveyor belt.

The elongate rotor unit comprises:
an elongate rotor comprising an elongate shaft which is rotatable around a rotation axis and radially outwardly from the elongate shaft extending rotor elements defining a maximum radius of the elongate rotor with respect to the rotation axis, and
a non-rotatable part comprising non-rotatable elements which viewed in a direction of the rotation axis of the elongate rotor are spaced with respect to each other, such that between two non-rotatable elements a slot is provided for at least a portion of one of the rotor elements of the elongate rotor, wherein each slot has a first end located at a distance from the rotation axis larger than the maximum radius of the elongate rotor and a second end located at a distance from the rotation axis smaller than the maximum radius of the elongate rotor.

At least portions of the rotor elements can rotate through the slots provided by the non-rotatable elements. For example, at least one radially extending protrusion of a rotor element may pass through at least a portion of the slot each rotation around the rotation axis, wherein at least one of the outer ends of one of these protrusions seen radially from the rotation axis defines the maximum radius of the elongate rotor with respect to the rotation axis. Alternatively, each rotor element may be a star-shaped rotor element with for example six radially extending identical protrusions such as shown in the figures of WO 2020/242303, wherein the outer end of each protrusion defines the maximum radius of the elongate rotor with respect to the rotation axis. The number of protrusions of each rotor element may vary. An inwardly into the rotor extending slot is provided with the above identified positions of the first end and opposite second end of the slot. At least a portion of this slot is defined by inwardly into the rotor extending non-rotatable elements. In addition, the ends of the non-rotatable elements defining the second end(s) of the slots cannot be connected with each other, otherwise the rotor element(s) cannot pass through this end and will be blocked. In other words, the second end of the slot is an open second end. As a result of the open second end and the position of the related ends of the non-rotatable elements, an elongate rotor unit may be provided with a relatively large discharge. This discharge mainly extends in the direction of the rotation axis. Hence, product that is being pulled inside the elongate rotor unit can be removed from the inside of the elongate rotor unit through this discharge. Removing product out of the elongate rotor unit reduces the risk of product clogging inside the elongate rotor unit. The non-rotatable part of the elongate rotor unit known from WO 2020/242303 is a plate with slots, wherein each end of the slots is closed by plate end portions. This known slotted plate is arranged around the shaft in a manner that product may be captured inside the elongate rotor unit which may cause undesired accumulations of product inside the elongate rotor unit. By providing the discharge by means of the non-rotatable elements these undesired accumulations inside the elongate rotor or the rotor unit can be reduced or even almost excluded. Hence, an improvement of the agricultural processing of the device and a reduction of the risk of clogging of the product in the elongate rotor unit can be obtained by the device disclosed in this document. Further, the inwardly into the rotor extending non-rotatable elements facilitate preventing in an efficient way that product remains sticking to the rotor elements which reduces the risk further that product is drawn into the interior of the rotor unit. In addition, the multiple non-rotatable elements are positioned relatively far away from the product flow in the product passage, compared to the known single slotted plate, wherein this increased distance results in more available contact area of the rotor elements for the product to improve the product flow in the product passage or after the product passage.

The word elongate is being used in this document to indicate that with respect to the dimensions of a component of the device, such as the pick-up mechanism and/or the rotor unit, the largest dimension of the component extends in the length (longitudinal) direction, such that the length of that component is larger than its width and height thereof. In this document the length direction of the pick-up mechanism and/or the rotor unit extends in the same direction as the (virtual) rotation axis of at least the elongate rotor of the elongate rotor unit

In one aspect, the first end of each slot is an open end between two spaced non-rotatable elements. An open first end of each slot reduces the likelihood that product remains sticking in the slot and/or accumulates in this end. Hence, the risk of clogging of the product in the elongate rotor unit may be further reduced. This first open end provides the discharge side of the rotor unit in the direction of the conveyor belt, such that a relatively unobstructed product flow can be achieved towards the conveyor belt.

In another aspect, ends of the non-rotatable elements defining the second ends of the slots are arranged close to the shaft at a distance of 5 cm or less, preferably of 2 cm or less.

Such a minimal distance between ends of the non-rotatable elements and the shaft ensures that the inwardly into the rotor extending sections of the non-rotatable elements prevent in an effective way that product remains sticking to the rotor elements, i.e. this minimal distance facilitates the cleaning effect by the spaced non-rotatable elements on the rotor elements. In addition, these inwardly into the rotor extending sections may increase the contact surface of the rotor elements with the product and therefore the grip of the rotor elements on the product in the product passage between rotor and pick-up mechanism. In other words, the maximum protruding distance of the rotor elements with respect to the non-rotatable elements is relatively large. By providing the second ends of the slots relatively close to the shaft as mentioned above and/or by configuring ends of the non-rotatable elements defining the second ends of the slots as a scraper for scraping product from the shaft, an advantageously scraping effect of the shaft may be obtained by means of the ends of the non-rotatable elements, such that product wrapping around the shaft can be scraped off and/or kept off the shaft in a relatively early stage.

In a further aspect, a section of each non-rotatable element located outside the maximum radius of the elongate rotor is adapted to deflect a product flow from the product passage, in particular product flow can be deflected in a less vertical direction by means of this section of each non-rotatable element.

As a result of the position of the first end of the slot outside the rotor, each non-rotatable element comprise a section located outside the maximum radius of the rotor. These sections can be configured or shaped to deflect the main direction of movement of the product coming from the product passage, such that the product can be guided in a more efficient or optimal manner to the conveyor belt by these sections. These sections may further be used to deflect a product flow out of the product passage in a less vertical direction such that the distance between conveyor belt and pick-up mechanism/rotor unit may be reduced to obtain a more compact design of the device.

The section of each non-rotatable element located inside the maximum radius of the elongate rotor may be crescent shaped. A crescent shaped inner section of each non-rotatable element facilitates scraping product off the shaft and/or the rotor elements, such that the risk is reduced that product accumulates inside the rotor unit and/or that product is drawn inside the rotor unit. The non-rotatable elements as whole may be sickle shaped, wherein the section of each non-rotatable element located outside the maximum radius of the rotor provides the “handle” of a sickle to deflect the product into the desired direction for an optimal product distribution on the conveyor belt.

Seen in a cross section, the non-rotatable part may be located around the shaft in such a manner that maximally 120 degrees of the circumference of the shaft is surrounded by the non-rotatable part. As a result of the position of the second ends of the slots provided by the non-rotatable elements and the portion of the shaft surrounded by the non-rotatable part, the elongate rotor unit disclosed in this document can be provided with a discharge which mainly extends in the direction of the rotation axis of the rotor, i.e. in the length direction of the elongated rotor unit. A minimum width dimension of this discharge may be desired to prevent clogging in the rotor unit under certain processing conditions, wherein this minimum width dimension of the discharge can be achieved by providing the non-rotatable part over maximally 120 degrees, over the circumference of the shaft. The width dimension of the discharge may extend along a virtual horizontal line between the ends of the non-rotatable elements defining the second ends of the slots and the maximum radius of the rotor, such that product inside the rotor, for example between portions of adjacent rotor elements, may be removed from the rotor through this discharge.

In another aspect, the non-rotatable part comprises a frame, for example an elongate housing section covering substantially the upper part of the elongate rotor, wherein each non-rotatable element is connected individually to the frame, preferably the distance between ends of the non-rotatable elements defining the second end of the slot and the rotation axis is adjustable.

An elongate housing section of the non-rotatable part may be desired, inter alia, for safety reasons. Such a housing section is also known from WO 2020/242303, wherein the slotted plate is connected to on both sides to the housing section such that the non-rotatable part (housing section and slotted plate) lies completely (100%) around circumference of the shaft, see FIG. 3 of WO 2020/242303. By connecting each non-rotatable element individually to a frame of the non-rotatable part, such as the housing section, in particular to one side of the housing section only, the above advantages of the non-rotatable elements and the corresponding slots can be obtained in a relatively easy manner from a constructional point of view. However, instead of the housing section, the frame may also be provided by a bar or the like extending in the direction of the rotation axis of the rotor, wherein each non-rotatable element is connected individually to the frame. Optionally, the non-rotatable elements may be connected in a adjustable manner to the frame, for example a pivotable manner, such that the distance between ends of the non-rotatable elements defining the second end of the slot and the rotation axis can be manually or automatically adjusted.

A sloped guide member of the elongate pick-up mechanism may define a sloped product passage section of the product passage between the maximum radius of the elongate rotor and the sloped guide member, wherein the angle of the sloped product passage section is at least 20 degrees relative to a horizontal plane, preferably this angle is between 30 degrees and 75 degrees. By means of the rising slope formed by the guide member, the product, for example grass, is to be moved by means of the pick-up mechanism at relatively high speed slanting upwards as well as backwards towards the conveyor belt, i.e. the product flow leaving the sloped guide member has an angle of at least 20 degrees relative to a horizontal plane, preferably this angle is between 30 degrees and 75 degrees. In other words, the product flow is altered by means of the sloped guide member so that the product flow in the product passage section between pick-up mechanism and conveyor belt no longer extends substantially in the horizontal direction, but also comprises a vertical component. The guide member forming a slope for the product improves the product flow between the pick-up mechanism and the conveyor belt, in particular the product flow is being improved drastically in the case of a relatively wet product. A product outlet side of the sloped guide member directed towards the conveyor belt is located, owing to the slope, at a height relative to the conveyor belt, for example of at least 100 mm, preferably at least 150 mm, so that, as a result of a falling motion under the effect of gravity, the product falls from the product outlet side of the product passage section onto the conveyor belt. Owing to the falling motion of the product towards the conveyor belt provided by means of the guide member and the elongated rotor unit, accumulation/clogging of product near the conveyor belt is prevented or in any event minimized. In addition, the height difference of at least 100 mm, preferably at least 150 mm, provided with the sloped guide member, prevents, directly after the pick-up mechanism and the elongate rotor unit, the product being pulled by the conveyor belt at an angle for sideways deposition by means of the conveyor belt, as is the case if the product flow between pick-up mechanism and conveyor belt extends substantially in a horizontal direction, so that the chance of clogging as well as an uneven product flow is also prevented or minimized.

The sloped guide member of the elongate pick-up mechanism and the vertical position of the rotor unit with respect to the pick-up mechanism provide the product passage section therebetween. An improved product flow in the product passage section may be provided if the distance between the elongate rotor unit and the elongate pick-up mechanism near an inlet of the product passage section is larger than near an outlet of the product passage section. By means of this minimal distance near the outlet, more grip on the product by the rotor elements may be obtained. The outer portion of the rotor element extending in the product flow near the outlet may rotate with a relatively high circumferential speed, normally higher than the circumferential speed of the pick-up mechanism, such that an improved product flow can be obtained by the sloped guide member in the direction of the conveyor belt. Such a product passage section may also facilitate an improved distribution of product on the conveyor belt in that product can be moved further backwards on the conveyor belt. The product passage between the pick-up mechanism and the rotor unit may comprise an introduction product passage section and the sloped product passage section. A product outlet side of the introduction product passage section may be in direct communication with the product inlet side of the sloped product passage section. The introduction product passage section is provided between the rotor unit and the pick-up mechanism section with pick-up teeth for product transport, the sloped product passage section is provided between the rotor unit and the sloped guide member of the pick-up mechanism, i.e. a section of the pick-up mechanism without pick-up teeth. The introduction product passage section has a smaller slope, i.e. having a slope angle<20 degrees, than the sloped product passage section, i.e. having a slope angle>20 degrees, preferably between 30-75 degrees.

The invention further relates to a self-propelled agricultural machine, for example a self-propelled merger. Said self-propelled agricultural machine being provided with at least one device as disclosed in in this document, preferably at least two devices as disclosed in in this document. The invention may also relate to a pulled agricultural machine provided with at least one device as disclosed in in this document. Finally, the invention relates to the use of an agricultural machine comprising at least one device as disclosed in in this document.

The aspects described above as well as other aspects of the device or the agricultural machine will be explained hereunder on the basis of exemplary embodiments in combination with the figures. The invention is not, however, limited to the exemplary embodiments described hereunder. Rather, a number of adaptations and modifications are possible, which also make use of the idea of the invention claimed in the claims and consequently fall within the scope of protection. In particular, the possibility is mentioned of combining the features/aspects that are only mentioned in the description and/or are shown in the figures, with the features of the claims in so far as compatible.

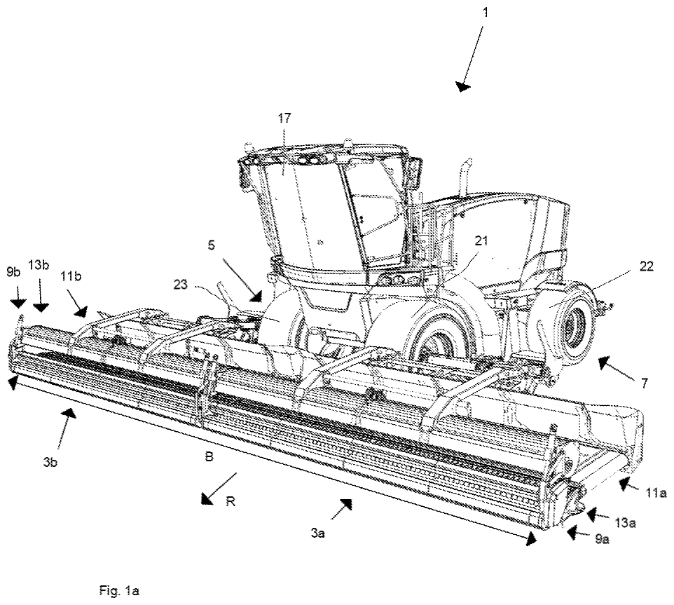

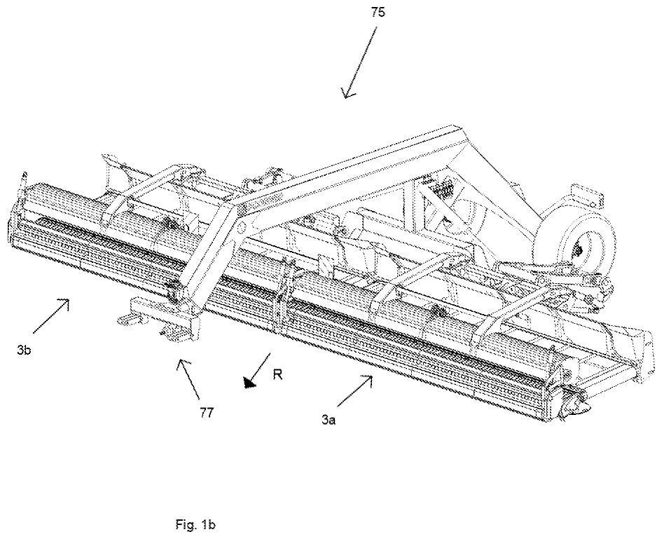

FIG. 1a shows a perspective view of a self-propelled agricultural machine in the operating mode in which two devices are in the working position;

FIG. 1b shows a perspective view of a pulled agricultural machine in the operating mode in which two devices are in the working position

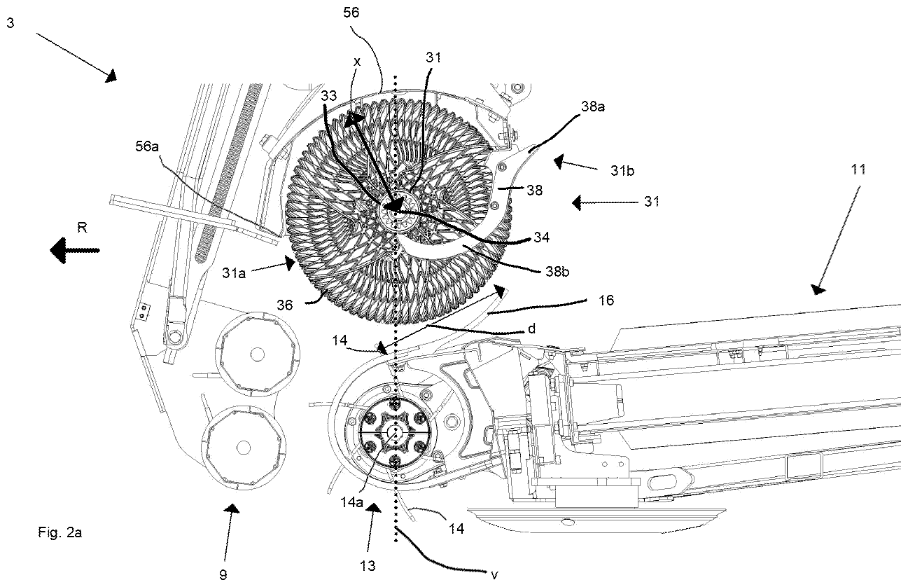

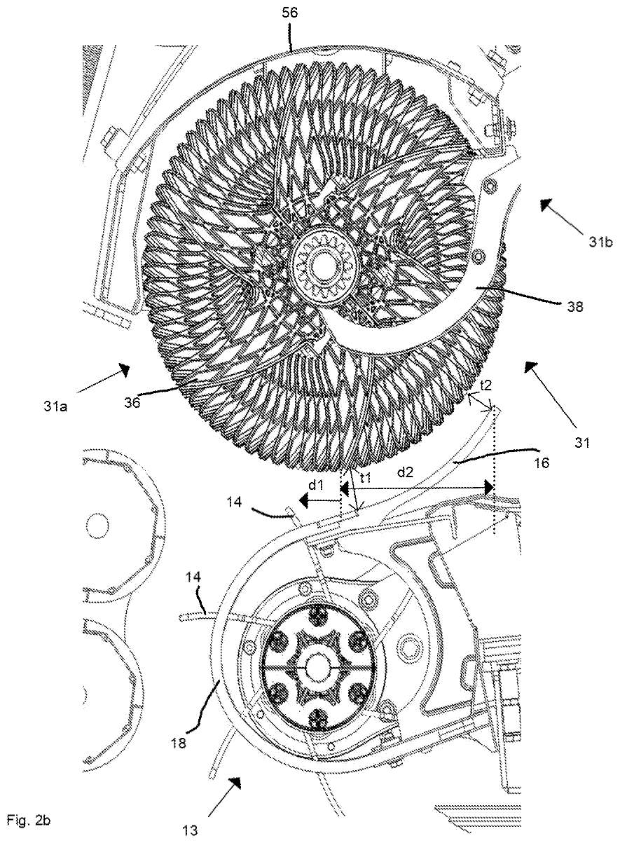

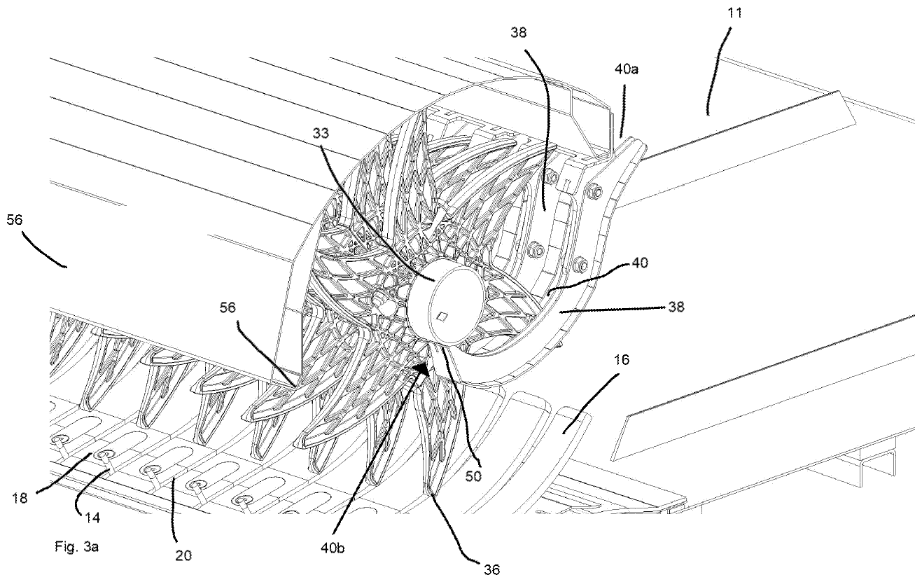

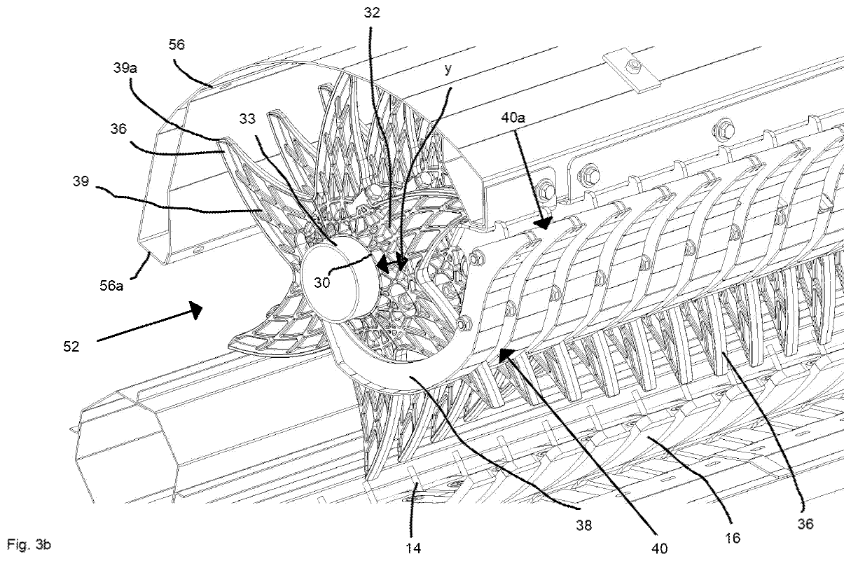

FIG. 2a,b show cross-sections of main components of a device for carrying out agricultural processing, wherein FIG. 2b shows an enlarged view of FIG. 2a;

FIG. 3a-c show perspective enlarged views of a portion of a device for carrying out agricultural processing.

In the figures, the same components are indicated with the same reference signs.

FIG. 1a shows a self-propelled agricultural machine, more particularly a self-propelled merger 1. Although the self-propelled agricultural machine claimed in the claims is particularly suitable for use in a merger 1, the device described in the claims may also be used in other self-propelled haymaking machines or self-propelled agricultural machines, in particular agricultural machines which can be moved over the land in the direction of travel at relatively high speeds of travel in order to perform an agricultural operation, in which the product is deposited on the land transversely/laterally with respect to the direction of travel.

FIG. 1b shows a pulled agricultural machine 75 which can be connected to a vehicle, for example a tractor, by means of a coupling 77. The pulled machine 75 contains the two devices to be discussed in more detail below.

Reference is made to WO 2020/242 for more general details of the agricultural machines shown in FIGS. 1a, b. The devices 3a, 3b shown in FIGS. 1a, b are identical or almost identical. These devices 3a, 3b will be identified with reference sign 3 hereafter. The product-lifting mechanism 13a, 13b is mentioned pick-up mechanism in this document, which will be identified with reference sign 13 hereafter, conveyor belt 11a, 11b will be identified with reference sign 11 hereafter and introduction mechanism 9a, 9b is mentioned feed mechanism below and identified with reference sign 9 hereafter.

FIGS. 2a, b show details of the device 3 disclosed in this document. The device 3 for carrying out agricultural processing is movable in a direction of travel R over land. The device 3 comprises:
an one elongate pick-up mechanism 13 for picking up product (not shown), such a plant material product, from the land, for example for picking up plant material, such as hay, grass or alfalfa or a similar product;
at least one conveyor belt 11 which is positioned with respect to the elongate pick-up mechanism 13 in such a way that the product picked up from the land by means of the elongate pick-up mechanism 13 can be moved in the direction of the conveyor belt 11, wherein by means of the conveyor belt 11 the product can be conveyed in at least one transport direction extending lateral to the direction of travel R (to the left or right of the direction of travel R) and can be deposited on the land, for example for forming a windrow, and
an elongate rotor unit 31 which is arranged above the elongate pick-up mechanism 13, wherein in use a product passage indicated with arrow d is provided between the elongate rotor unit 31 and the elongate pick-up mechanism 13 in the direction of the conveyor belt 11.

The elongate rotor unit 31 will be described with reference to FIGS. 2a-3c, wherein the rotor unit 31 comprises:
an elongate rotor 31a comprising an elongate shaft 33 which is rotatable around a (virtual) rotation axis 34 and radially outwardly from the elongate shaft 33 extending rotor elements 36 defining a maximum radius x of the elongate rotor 31a with respect to the rotation axis 34, and
a non-rotatable part 31b comprising non-rotatable elements 38 which viewed in a direction of the rotation axis 34 of the elongate rotor 31a are spaced with respect to each other, such that between two non-rotatable elements 38 a slot 40 is provided for at least a portion of one of the rotor elements 36 of the elongate rotor 31a, wherein each slot 40 has a first end 40a (FIG. 3a-c) located at a distance from the rotation axis 34 larger than the maximum radius x of the elongate rotor 31a and a second end 40b (FIG. 3a) located at a distance from the rotation axis 34 smaller than the maximum radius x of the elongate rotor 31a. By means of the non-rotatable elements 38 having ends 50 ending near the shaft 33 a discharge 52 (FIG. 3b) is provided as a discharge (opening) 52. By means of this discharge 52 undesired accumulations can be removed from the interior of the elongated rotor unit 31. Hence, a reduction of the risk of clogging of the product in the elongate rotor unit 31 can be obtained by the device 3 shown in the figures. Each rotor element 36 comprises a disc-like section y (FIG. 3b) having a virtual outer (circular) circumference 32 (FIG. 3b) and an inner (circular) circumference 30 (FIG. 3b) mounted on the shaft 33. Projections 39 (FIG. 3b) of each rotor element 36 extend radially away with respect to the rotation axis from the outer circumference 32. Between two adjacent projections 39 of each rotor element a V-shaped opening is provided. The number of projections 39 may vary, wherein in the embodiment shown each rotor element has six projections 39. The outer ends 39a of the rotor elements 36 define the maximum radius x of the elongate rotor 31a, wherein the radius x of the elongate rotor 31 is at least 150 mm measured from the rotation axis. The shaft 33 has a radius of at least 20 mm measured from the rotation axis, wherein the outer circumference 32 has a constant distance of least 30 mm measured from the circumference of the shaft. Further, the inwardly into the rotor 31a extending non-rotatable elements 38 facilitate preventing in an efficient way that product remains sticking to the rotor elements 36 which further reduces the risk that product is drawn into the interior of the rotor unit 31. By using rotor element 36 as shown in combination with the non-rotatable elements 38 providing the second slot end 40b (FIG. 3a) located at a distance from the rotation axis 34 smaller than the radius of the outer circumference 32, a beneficial scraping effect can be obtained with the ends of the non-rotatable elements defining the second ends 40b of the slots. Product in the product passage may enter the V-shaped openings of the rotor elements 36, wherein the ends of the non-rotatable elements defining the second ends 40b of the slots 40 are located “under” the product which reduces the risk that product is able to reach the shaft such that wrapping around the shaft 33 can be reduced significantly. The interior space of the rotor unit 31 of the device 3 shown in figures is mainly bounded by an upper housing section 56 of the non-rotatable part 31b and, on a lower side, by outer ends of the rotor elements 36 defining a maximum radius x.

The elongate housing section 56 covers substantially the upper part of the elongate rotor 31a, wherein each non-rotatable element 38 is connected individually to the housing section 56. From a constructional point of view such a non-rotatable part 31b can be made relatively easily. However, it is also possible to manufacture the non-rotatable elements 38 in one piece with the housing section 56. Instead of the housing section 56 or in addition to the housing section 56, a frame (not shown) may be provided by an elongate bar or the like extending in the direction of the rotation axis of the rotor, wherein each non-rotatable element 38 is connected individually to the frame.

The first end 40a of each slot 40 is also an open end between two spaced non-rotatable elements 38. This first open end 40a provides the discharge side of the rotor unit 31 in the direction of the conveyor belt 11. An open first end of each slot reduces the likelihood that product accumulates in this end 40a and/or remains sticking in the slot 40.

In the embodiment of the device 3 shown in the figures the ends 50 of the non-rotatable elements 38 defining the second ends 40b of the slots are arranged relatively close to the shaft 33 for example at a distance of less than 2 cm or even less than 1 cm. By providing the second ends 40b of the slots relatively close to the shaft as mentioned above and/or by configuring ends 50 (or end portions) of the non-rotatable elements 38 defining the second ends 40b of the slots 40 as a scraper for scraping product from the shaft, an advantageously scraping effect of the shaft 33 may be obtained by means of the ends 50 of the non-rotatable elements 38, such that product wrapping around the shaft 33 can be scraped off and/or kept off the shaft in a relatively early stage.

A section 38a of each non-rotatable element 38 located outside the maximum radius x of the elongate rotor 31a is adapted to deflect a product flow from the product passage d, in particular product flow can be deflected in a less vertical direction by means of this section 38a of each non-rotatable element 38. The section of each non-rotatable element 38b located inside the maximum radius x of the elongate rotor 31a is crescent shaped. The non-rotatable elements 38 as whole is sickle shaped.

The slot 40 also has two sections, i.e. a first slot section defined between two sections 38a of two non-rotatable elements 38 located outside the maximum radius x of the elongate rotor 31a and a second slot section defined between two sections 38b of two non-rotatable elements 38 located inside the maximum radius x of the elongate rotor 31a. The distance between two sections 38a of two non-rotatable elements 38 defining the width of the first slot section near the second slot section is smaller than the distance between the two sections 38b of the two non-rotatable elements 38 near the first end 40a. The distance between two sections 38b of two non-rotatable elements 38 defining the width of the second slot section near the first slot section is smaller than the distance between the two sections 38b of the two non-rotatable elements 38 near the first end 40a. To further reduce the risk of product sticking in the slot 40, the first slot section becomes wider in the direction of the first end 40a of the slot 40. The width of the second section of the slot 40 may be minimally larger, for example less than 5 mm, than the thickness (seen in the direction of the rotation axis 34) of the rotor element 36.

Seen in a cross section, the non-rotatable part 38, 56 is located around the shaft in such a manner that maximally 90% of the circumference of the shaft 33 is covered or surrounded by the non-rotatable part, i.e. only the circumference of the shaft located between end 50 of the non-rotatable element 38 and end 56a of the upper housing section 56 is not covered or surrounded by the non-rotatable part 38, 56. The space between these end 50 of the non-rotatable element 38 and end 56a of the upper housing section 56 also define the width dimension of the additional discharge opening 52, wherein the length direction of the discharge opening 52 mainly extends in the direction of the rotation axis 34 of the rotor 31a, i.e. in the length direction of the elongated rotor unit 31, see for example FIG. 3b.

FIG. 2a,b show that the elongate pick-up mechanism 13 comprises a sloped guide member 16 defining a sloped product passage section d2 (FIG. 2b) of the product passage d (FIG. 2a) between the maximum radius x of the elongate rotor 31a and the sloped guide member 16, wherein the angle of the sloped product passage section is at least 20 degrees relative to a horizontal plane, preferably this angle is between 30 degrees and 75 degrees. An improved product flow in the product passage section may be provided if a distance t1 between the elongate rotor unit 31a and guide member 16 of the elongate pick-up mechanism 13 near an inlet of the product passage section d2 is larger than a distance t2 near an outlet of the product passage section d2. The product passage d between the pick-up mechanism 13 and the rotor unit 31a also comprises an introduction product passage section d1. A product outlet side of the introduction product passage section d2 may be in direct communication (see FIG. 2b vertical dotted line between sections d1, d2) with the product inlet side of the sloped product passage section. The introduction product passage section d1 is provided between the rotor unit and the pick-up mechanism section with pick-up teeth 14 for product transport, the sloped product passage section d2 is provided between the rotor unit 31a and the sloped guide member 16, i.e. a section of the pick-up mechanism without pick-up teeth 14. The introduction product passage section d1 has a smaller slope, i.e. having a slope angle<20 degrees, than the sloped product passage section d2, i.e. having a slope angle>20 degrees, preferably between 30-75 degrees.

The elongate pick-up mechanism 13 is arranged with respect to the elongate rotor unit 31 such that through the teeth rotation axis 14a of the elongate pick-up mechanism 13 and the shaft 33 of the rotor 31a a vertical line v (FIG. 2a) extends. The vertical line v through the teeth rotation axis 14a of the elongate pick-up mechanism 13 may also substantially coincides with the rotation axis 34 of the shaft 33 of the rotor 31a (not shown). This alignment between pick-up mechanism 13 and rotor unit 31 provides an optimized product flow therebetween.

The pick-up mechanism 13 is provided with baleen-shaped strips 18 which are mounted next to each other like the non-rotatable elements 36 of the rotor unit 31a in such a way that a pitch distance is present between two strips 18, which defines a slot-shaped opening 20 (FIG. 3a), in which a number of movable pick-up teeth 14 of the pickup mechanism 13 are mounted rotatably about a teeth rotation axis 14a relative to the strips 18, wherein the pickup teeth 14, viewed in a radial direction from the teeth rotation axis 14a, project relative to the strips 18. The sloped guide member 16 is formed by extending the baleen-shaped strips 18 (see FIG. 2b), wherein the extended segments of the strips provide the sloped guide member 16. The slot shaped opening 20 is also provided between the extended segmented strips, wherein the distance between the extended segmented strips defining the opening therebetween may be larger than the distance of the slot shaped opening between two strips 18. Such an opening also reduces the risk that product will be clamped therein. The slot shaped opening between the extended segmented strips may taper in the direction of the outlet of the product passage, i.e. the distance of the slot shaped opening between the segmented strips near the strips 18 is smaller than the distance between the segmented strips near the outlet.

Seen in the direction of rotation of the shaft 33, the rotor elements 36 of the elongate rotor 31a mounted on the shaft 33 rotate between two adjacent pickup teeth 14 of the elongate pick-up mechanism 13 or vice versa. In other words, the rotor elements 36 rotate above the strips 18 and the extended segments thereof between two openings 20. In this way, it is possible to align the pickup mechanism 13 with respect to the rotor unit 31 as discussed above with the vertical line v, and there is no area or at least a reduced area where the teeth and/or the rotor elements have no contact with the product for moving/transporting the product in the product passage d. In other words, the rotor unit 31 may assist the pick-up mechanism 13 in a more or relatively early stage for moving the product over the sloped guide member 16 toward the conveyor belt 11. In addition, seen from a side view the maximum radius of teeth 14 defines a working circle which may have an overlap (not shown) with a working circle defined by the maximum radius r of the rotor elements 36 to further improve product flow in the product passage d. Further, it is possible to obtain a relatively compact device 3 with the various components, in particular the rotor unit 31 and the pickup mechanism 13, shown in the figures.

Further, the device 3 is configured that the outer ends 39a of the rotor elements 36 have a larger circumferential speed than the outer ends of the teeth 14 of the pick-up mechanism 3. This configuration of the device 3 provides an improved product flow in the product passage d in that that the rotor elements 36 pull the product away from the teeth 14 in an effective manner, even when a relatively wet product is being processed by the device 3. Further, this configuration reduces the risk that product is drawn inside the pickup mechanism 3 by means of the teeth 14. For example, the rotor 31a may have a larger radius x than the radius of the teeth and/or the rotor 31a may be driven at a higher rotation speed than the rotation speed of the teeth 14.

As shown in the figures, the device 3 is further provided with a feed mechanism 9 comprising at least two elongate rolls 72, 74 mounted substantially parallel as well as rotatably. The two elongate rolls 72, 74 are provided for facilitating the elongate pick-up mechanism 13 to pick up product from the land, wherein a product throughput is to be provided between each elongate roll 72, 74 and the elongate pick-up mechanism, wherein, viewed in the direction of travel R, the elongate pick-up mechanism 13 is installed between the feed mechanism 9 and the conveyor belt 11.

1. A device for carrying out agricultural processing which is movable in a direction of travel over land, the device comprising:
at least one elongate pick-up mechanism for picking up a product from the land,
at least one conveyor belt which is positioned with respect to the elongate pick-up mechanism in such a way that the product picked up from the land by the elongate pick-up mechanism is movable in a direction of the conveyor belt, wherein by the conveyor belt the product is conveyed in at least one transport direction extending lateral to the direction of travel and deposited on the land, and
an elongate rotor unit which is arranged above the elongate pick-up mechanism, wherein in use a product passage is provided between the elongate rotor unit and the elongate pick-up mechanism in the direction of the conveyor belt, wherein the elongate rotor unit comprises:
an elongate rotor comprising an elongate shaft which is rotatable around a rotation axis and radially outwardly from the elongate shaft extending rotor elements defining a maximum radius of the elongate rotor with respect to the rotation axis, and
a non-rotatable part comprising non-rotatable elements which viewed in a direction of the rotation axis of the elongate rotor are spaced with respect to each other, such that between two of the non-rotatable elements a slot is provided for at least a portion of one of the rotor elements of the elongate rotor, wherein each slot has a first end located at a distance from the rotation axis larger than the maximum radius of the elongate rotor and a second end located at a distance from the rotation axis smaller than the maximum radius of the elongate rotor.

2. The device according to claim 1, wherein the first end of each slot is an open end between two spaced non-rotatable elements.

3. The device according to claim 1, wherein ends of the non-rotatable elements defining the second ends of the slots are arranged at a distance of 5 cm or less from the shaft.

4. The device according to claim 1, wherein ends of the non-rotatable elements defining the second ends of the slots are configured as a scraper for scraping product from the shaft.

5. The device according to claim 1, wherein a section of each non-rotatable element located outside the maximum radius of the elongate rotor is adapted to deflect the product flow from the product passage.

6. The device according to claim 1, wherein a section of each non-rotatable element located inside the maximum radius of the elongate rotor is crescent shaped.

7. The device according to claim 1, wherein seen in a cross section, the non-rotatable part is located around the shaft in such a manner that maximally 120 degrees of a circumference of the shaft is surrounded by the non-rotatable part.

8. The device according to claim 1, wherein the non-rotatable part comprises a frame, comprising an elongate housing section covering substantially an upper part of the elongate rotor, wherein each non-rotatable element is connected individually to the frame.

9. The device according to claim 1, wherein a sloped guide member of the elongate pick-up mechanism defines a sloped product passage section of the product passage between the maximum radius of the elongate rotor and the sloped guide member, wherein the angle of the sloped product passage section is at least 20 degrees relative to a horizontal plane.

10. The device according to claim 9, wherein the elongate pick-up mechanism comprises baleen-shaped strips, which are mounted next to each other like the non-rotatable elements of the rotor unit in such a way that a pitch distance is present between two strips, which defines a slot-shaped opening, in which a plurality of movable pick-up teeth of the pickup mechanism are mounted rotatably about a teeth rotation axis relative to the strips, wherein the pickup teeth, viewed in a radial direction from the teeth rotation axis, project relative to the strips.

11. The device according to claim 10, wherein the sloped guide member is formed by extending the baleen-shaped strips, wherein the extended segments of the strips provide the sloped guide member.

12. The device according to claim 10, wherein the elongate pick-up mechanism is arranged with respect to the elongate rotor unit such that through the teeth rotation axis of the elongate pick-up mechanism and the shaft of the rotor a vertical line extends.

13. The device according to claim 10, wherein seen in a direction of rotation of the shaft, the rotor elements of the elongate rotor mounted on the shaft rotate between two adjacent pickup teeth of the elongate pick-up mechanism or vice versa.

14. The device according to claim 1, wherein a distance between the elongate rotor unit and the elongate pick-up mechanism proximate an inlet of the product passage is larger than a distance between the elongate rotor unit and the elongate pick-up mechanism proximate an outlet of the product passage.

15. The device according to claim 1, wherein the device further comprises a feed mechanism comprising at least two elongate rolls mounted substantially parallel as well as rotatably for facilitating the elongate pick-up mechanism to pick up product from the land, wherein a product throughput is positioned between each elongate roll and the elongate pick-up mechanism, wherein, viewed in the direction of travel, the elongate pick-up mechanism is installed between the feed mechanism and the conveyor belt.

16. The device according to claim 1, wherein each slot has a first slot section defined between two sections of two non-rotatable elements located outside the maximum radius of the elongate rotor and a second slot section defined between two sections of two non-rotatable elements located inside the maximum radius of the elongate rotor, wherein a distance between two sections of two non-rotatable elements defining the first slot section near the second slot section is smaller than a distance between the two sections of the two non-rotatable elements near the first end.

17. A self-propelled agricultural machine, for said self-propelled agricultural machine comprising at least one device according to claim 1.

18. A pulled agricultural machine comprising at least one device according to claim 1.

19. (canceled)
